(19) United States
(12) Patent Application Publication
(10) Pub. No.: US 2015/0019235 A1
(43) Pub. Date: Jan. 15, 2015

(54) PLATFORM FOR PROVIDING NEGOTIATED RATES ON HEALTHCARE

(71) Applicant: Joydeep Roychowdhury, Powell, OH (US)

(72) Inventor: Joydeep Roychowdhury, Powell, OH (US)

(21) Appl. No.: 13/941,599

(22) Filed: Jul. 15, 2013

(51) Int. Cl. G06Q 30/06; G06Q 50/22

(52) U.S. Cl. CPC G06Q 30/0627; G06Q 50/22; G06Q 40/08
USPC 705/2

(57) ABSTRACT

A method for providing negotiated rates or contracted rates on healthcare services for user(s) or patient(s) on request for services such as, detail of providers, cost of the service based on negotiated rates, emergency services, location, health record, claims processing alerts, walk-in-clinic integration, appointment alerts through a mobile based application. Where a user(s) or patient(s) may receive all the required information on the spot, which enables a user(s) or patient(s) to take personalized decision.

### FIELD OF THE INVENTION

The present invention relates generally to a system and method for providing negotiated rates to the patient(s) or user(s) on healthcare services. More particularly the present invention provides a mobile application for identifying services and providers, as well as other information based on user inputs concerning symptoms or conditions or diseases where the application enables the patients or users to compare cost of doctors, hospitals, clinics, labs or others i.e. to weigh cost and quality information in selecting a service, procedure, product, facility and/or to identify the best quality level at their desired cost level before obtaining services.

### BACKGROUND OF THE INVENTION

The selection of healthcare services, products and providers may be difficult for consumers for a number of reasons. Often, meaningful healthcare information is unavailable to consumers. For example, health-related costs to the consumer in any given market for any given procedure may vary, and the consumer may not have access to the current costs they may incur for receiving a health-related service or product. In addition, the quality of care may vary within any given market. For example, various providers may have differing levels of experience or skill for a given procedure, product or service, but this information typically is not available to consumers. As a result, consumers often make choices concerning their healthcare products, service and/or providers without the benefit of accurate cost and quality information.

In a variety of contexts, it is difficult for a patient or other user to obtain actionable information regarding needed products or services because of various barriers between the patient's indication of what the patient needs and existing data concerning available products or services. The case of a patient or other user desiring information regarding medical services is illustrative. Many sources of information are available to identify medical facilities and service providers based on specialty. Such sources of information include telephone books and web-based resources. Unfortunately, while a patient or other user typically knows what symptoms are being presented or, in some cases, what type of medical consultation is desired, in many cases the patient or user will not necessarily know what specialty is needed. That is, a patient with particular symptoms may not be able to determine that those symptoms indicate a particular condition requiring the service of a particular type of specialist, for instance, a gastroenterologist.

Even if the patient could somehow identify the correct specialty to address the need, a number of obstacles may remain. For example, the patient may be faced with the complication of identifying an “in network” service provider for his health plan, and/or identifying an appropriate service provider or facility close to the patient's location (which may be particularly problematic when the patient is traveling or is otherwise unfamiliar with the area).

While patients in need of urgent or emergency care may need immediate assistance, it is important to still allow such patients to make informed decisions in selecting their medical care provider, e.g., hospital, urgent care facility, physician, etc. Yet, a great deal of information to enable such decision-making is not available, or at least not readily available, to potential patients. While increasing numbers of patients are also opting for convenient care facilities or clinics for treatment of medical conditions requiring non-emergency or non-urgent care, information to enable potential patients to make informed decisions in selecting a particular convenient care facility has also been limited or, at least, not readily available. Such problems are exacerbated in that potential patients often select such facilities.

The mystery surrounding health-care pricing stems partly from the fact that hospitals and other providers generally don't publicize how much they're paid for services, which varies depending on who's footing the bill. Insurers, which often contract to receive lower prices for their customers, also have traditionally not revealed these negotiated amounts.

Even consumers with health insurance increasingly find that they have a stake in the cost of their care because they're paying a far bigger share out of their own pockets. Consumers also can't rely on their health plan's contracts to always deliver the lowest price, because the same insurer might pay widely varying amounts to different care providers

To find useful information, users generally have to do some digging and check multiple sites. Each takes a different approach, and they can be confusing. Several sites, including some offered by hospital associations, use listed charges the “sticker prices” that are typically much more than insurers pay. Other sites focus on the rates paid by private insurance plans or Medicare. It's also often unclear whether a Web site's estimate represents the full cost of a procedure, including, for instance, anesthesiology fees.

In view of all of these obstacles, the user may have difficulty in timely obtaining actionable information regarding medical services, e.g., what facility/type of specialist is needed, which appropriate specialists are in-network, which of those in-network specialists are nearby, where are the medical providers and what are the directions to get there, what other information is available to describe the user's condition, is the specialist/provider available and what are the wait times or other latency periods, is there anything the user needs to know or do until professional treatment is available, etc. It will be appreciated that the inability to timely obtain such information can be annoying in the best of circumstances but hazardous in some cases.

After selecting a particular care facility, the patient contacts the facility by using a contact mechanism provided by the search service, such as a unique phone number, electronic mail (email) address, and/or Short Message Service (SMS) address. Such phone number or email address is created such as that allows the patients to get less information. The accurate or sufficient information are not provided due which the patient can't make instant decision.

The spiraling costs of healthcare and health insurance result from a combination of factors, one of which is a lack of transparency. As a general rule, consumers are given the freedom to choose healthcare providers, but they are not provided with enough information to make cost-efficient choices. Healthcare providers generally do not publish their pricing information, which by itself makes it difficult for consumers to make informed decisions. To make things worse, the consumer is usually experiencing time pressure from the presence of sonic medical condition for which the consumer desires prompt treatment. Health insurance has, in the past, shielded most consumers from the impact of cost inefficiencies. As costs continue to grow, consumers increasingly have to reckon with the financial consequences of their decisions.

In the world of health care, it is nearly impossible for a patient to know what a given health care service or procedure will cost. This is due to the complex financial and contractual relationships between patients, providers, insurers, and employers. With no visibility into how the pricing works, patients are unable to budget spending, or comparison shop for better prices.

When health care providers contract with insurance companies, they agree on a negotiated rate schedule for the procedures the provider offers. These negotiated rates are particularly difficult to determine. These are largely considered confidential, and providers are unwilling to publish them, despite the fact that they have a significant impact on the patient's cost. Since many insurance plans require patients to pay the full negotiated rate before the patient's deductible is met, the negotiated rates are elemental in determining the patient's cost.

Due thereto, recently, research into a new system and method capable of not only improving the health care system but also satisfying both with services and cost, and also convenience for patient's or user to get desired information using web service, calling to services provider and through SMS or message has been actively conducted, but with the recent tendency a patient or user wants everything into simple manner or instantly.

There are many initiative action has been taken to overcome the above mentioned problem. While existing systems attempt to provide comprehensive quality and cost comparisons, they do not take into account the fact that enables consumers to make better-informed decisions concerning health-related products, services and/or procedures by generating a consumer healthcare guide that provides quality and/or cost information to the consumer. The guide may allow a consumer to understand their cost liability when choosing to receive health-related products, procedures or services. But these system and method provides cost range or average cost instead of accurate or exact cost with negotiated rates and also the system is not much user friendly.

Moreover, the consumer healthcare guide may be associated with other healthcare services. For example, the available system or method is assessable on a web interface and may be associated with “web-visits”. In this case patient or user is unable to get information details instantly, the patient or user may not be able to assess web interface due to unavailability of internet on the patient's location or physically incapability to access due to illness.

For a system to help patients understand the costs of medical care, it would need to bridge the gap and it is desirable to have a method and/or system for providing negotiated rates to the users on healthcare services, as well as providing other information, based on user inputs concerning symptoms or conditions which enable users to compare cost information for doctors, hospitals, and other healthcare providers before obtaining services.

The inventions disclosed herein are directed to an improved system and method that provides an application through which a patient or user can obtain negotiated costs on healthcare services, and identifies location of these services in desired area through a map. The invention also provides specific information that enables the user to resolve a unique need that the user may have and make a personalized decision regarding actions to address the needs.

### SUMMARY OF THE INVENTION

The present invention generally relate to providing negotiated rates on healthcare services to user(s) or patient(s) through a simplified mobile application which enable them to make informed decisions regarding their selections of providers, services, emergency, urgent, and/or convenient care facilities. User(s) or patient(s) is able to access information and data regarding providers, services, emergency, urgent, and convenient care over a network. In embodiments, such information is provided in response to searches conducted by user(s) or patient(s) for services satisfying specific criteria.

In one embodiment of present invention relates to a system for providing negotiated rate or contracted rates on healthcare services; the system is a mobile application through which a user(s) or patient(s) can retrieve information on a particular disease, symptom, procedure or any health related services. The system may include the functionality of linking medical information and providing user specific information. The user-specific information allows the user(s) or patient(s) to make an informed decision about medical treatment. The system may further be operative to tailor information in light of user(s) or patient(s) characteristics such as location or healthcare network membership.

In another embodiment of the present invention relates to a system for providing negotiated rates on healthcare services, the system comprises:
at least one server to receive request from user(s) or patient(s) regarding health care services, costs and geographical locations;
at least one searching database which communicates with the server;
identifying list of options for services which are selected from the group consisting of; detail of service provider, cost of the service based on negotiated rates, emergency services, map location, health record, claims processing alerts, walk-in-clinic integration, appointment alerts;
selecting at least one option from provided list of options;
wherein the system is a mobile application or also can be used as web application.

In an another embodiment of the present invention provides a method for obtaining healthcare service on negotiated rates or contracted rates for user(s) or patient(s) through an application or a computer implemented tool, the method comprising:
receiving a request for services from users or patients, wherein one or more types of services are selected from the group consisting of; detail of service provider, cost of the service based on negotiated rates, emergency services, map location, health record, claims processing alerts, walk-in-clinic integration, appointment alerts;
searching for information in the database;
identifying list of options with detailed information;
selecting at least one option from provided list of options;
transferring the request to service provider;
receiving acknowledgement from service provider;
sending the verification of the payment amount to a medical credit account associated with the user or patient;
approving the payment amount on the medical credit account from payer;
and transmitting the payment amount details to the health care provider;
wherein the user(s) or patient(s) receive all the required information on the spot, which makes a user(s) or patient(s) to take personalized decision regarding actions to address the needs.

User(s) or patient(s) are able to enter search criteria for finding emergency, urgent, and/or convenient care facilities by shortest wait times, closest physical proximity, highest quality ratings, etc. In determining proximity information, users may either provide their current location or indicate the exact geographic coordinates of the user's location.

These and other features and advantages of the present invention will become apparent to those skilled in the art from the following detailed description, wherein it is shown and described illustrative implementations of the invention, including best modes contemplated for carrying out the invention. As it will be realized, the invention is capable of modifications in various obvious aspects, all without departing from the spirit and scope of the present invention. Accordingly, the drawings and detailed description are to be regarded as illustrative in nature and not restrictive.

### BRIEF DESCRIPTION OF THE DRAWINGS

The following invention will be described with reference to the following drawings of which:

FIG. 1 is a schematic functional diagram of system for providing negotiated rates or contracted rates on healthcare services, in which various embodiment of the present invention may be practiced.

FIG. 2 is a diagram of an exemplary system for providing an interface for user that enables to access service providers list, cost, quality and/or rating and location from the data stored in database and presented by the server or processor.

FIG. 3 is a flowchart of a method for providing negotiated rates or contracted rates on healthcare services, in which various embodiment of the present invention may be practiced.

FIG. 4 is a block diagram of the system associated with obtaining health service information by user, in which various embodiment of the present invention may be practiced.

FIG. 5 depicts an exemplary mobile interface configured for user access.

FIG. 6 depicts an exemplary screen to provide user access to estimate cost.

FIG. 7 depicts an exemplary screen that provides an exemplary listing of doctor specialties that may be selected by the user as search criteria.

FIG. 8 depicts an exemplary screen for list of doctors with negotiated rates or contracted rate, address and ratings.

FIG. 9 depicts an exemplary screen enabling a user to search for hospitals within a defined geographic area and direction through map.

FIG. 10 depicts an exemplary screen enabling a user to search for remaining benefits.

FIG. 11 depicts an exemplary screen enabling a user to search for recommended labs that may be selected by the user as search criteria.

FIG. 12 depicts an exemplary screen providing health record of a user.

FIG. 13 depicts an exemplary depicts an exemplary screen for help needed, security and guidelines etc.

### DETAILED DESCRIPTION

The present invention will be described with respect to particular embodiments and with reference to certain drawings but the invention is not limited thereto but only by the claims. The drawings described are only schematic and are non-limiting. In the drawings, the size of some of the elements may be exaggerated or distorted and not drawn on scale for illustrative purposes. Where an indefinite or definite article is used when referring to a singular noun e.g. “a” or “art”, “the”, this includes a plural of that noun unless something else is specifically stated.

The present invention now will be described more fully hereinafter with reference to the accompanying drawings, in which some, but not all embodiments of the inventions are shown. While the following description details the preferred embodiments of the present invention is not limited in its application to the details of construction and arrangement of the parts illustrated in the accompanying drawings.

With reference to the figures, numerical designation has been given for each element to facilitate the reader's understanding of the present invention, and particularly with reference to the embodiments of the present invention illustrated in the figures; various preferred embodiments of the present invention are set forth below. The enclosed description and drawings are merely illustrative of preferred embodiments and represent several different ways of configuring the present invention. Although specific components, materials, configurations and uses of the present invention are illustrated and set forth in this disclosure, it should be understood that a number of variations to the components and to the configuration of those components described herein and in the accompanying figures can be made without changing the scope and function of the invention set forth herein.

The present invention provides a system and method for providing negotiated rate or contracted rates on healthcare services; the system is a mobile application through which a user(s) or patient(s) can retrieve information on a particular disease, symptom, procedure or any health related services. The system may include the functionality of linking medical information and providing user specific information. The user-specific information allows the user(s) or patient(s) to make an informed decision about medical treatment. The system may further be operative to tailor information in light of user(s) or patient(s) characteristics such as location or healthcare network membership.

The user(s) or patient(s) may access a number of data repositories herein termed database(s). The database(S), for instance, may include a procedure database, a disease/condition database, a symptoms database, and a provider database. Other databases could be provided consistent with the description provided below. By way of example, the procedure database may include information regarding medical procedures. This information may include steps of each procedure, the type of medical specialist capable of performing the procedure, possible complications of the procedure, negotiated or contracted rate on health care services, or other information.

The user(s) or patient(s) may also access information about the disease or medical condition, such as the description of the disease, tests that may be run to determine or diagnose the disease, common symptoms of the disease and common treatments of the disease. The present invention provides a single platform to access variety of services and information regarding disease or symptom on the spot through the system present in mobile/cell phone. The system comprises a server, at least one database and a user interface, wherein the server communicate among providers and users. The database contains all the information required by user(s) or patient(s) and the user interface is a platform to access all information.

One embodiment of the present invention relates to a system for providing negotiated rates on healthcare services, the system comprises:
at least one server to receive request from user(s) or patient(s) regarding health care services, costs and geographical locations;
at least one searching database which communicates with the server;
identifying list of options for services which are selected from the group consisting of; detail of service provider, cost of the service based on negotiated rates, emergency services, map location, health record, claims processing alerts, walk-in-clinic integration, appointment alerts;
selecting at least one option from provided list of options;
wherein the system is a mobile application or also can be used as web application.

The system provides negotiated rates or contracted rate on a particular disease or symptom to user(s) or patient(s) and information about service provider and location including, but not limited to, emergency services, urgent care clinics, retail clinics, specialists, physicians, pharmacies, or other medical providers. Moreover, the system may include information regarding each medical provider such as insurance network information, information regarding facilities (e.g. hours of operation, location, real-time wait times, etc. or other information), as well as reviews or quality ratings of services about each medical provider.

As mentioned, the described embodiments provide a system for estimating the provider negotiated rate or contracted rates on health care services include a mobile application analytics program that analyzes data (including claim data, provider data, and others) to present providers negotiated rates to the user(s) or patient(s). The application is operable on mobile and also can be hosted servers on web, and utilizes a number of databases to store and process the information.

When a user or patient is in need of medical assistance during a journey, locating a medical facility may be, in sonic cases, a critical decision. The decision becomes difficult when the user or patient (e.g., driver and/or passenger) is out of state or in unfamiliar territory. In any case, a user has health insurance when travelling; such user can obtain all information for a healthcare service prior to the visit, particularly if the health care is an emergency. The system of the present invention is a mobile application which is easy for user to retrieve details information and negotiated rate on the spot.

The system of the present invention provides sources of healthcare provider data including names and addresses of available doctors and hospitals, credentials and specializations of those providers, and cost information.

Where the present invention generally relate to connecting user(s) or patient(s) with emergency care, urgent care, and/or convenient care facilities. The system provides a platform for searching services for user(s) or patient(s) to connect with the emergency, urgent, and/or convenient care facility which best meets their needs or desires for medical treatment. According to embodiment as described above, the system is a mobile application for accessing, transmitting, and receiving information regarding healthcare services, including emergency, urgent, and/or convenient care facilities, for example, to enable user(s) or patient(s) to make informed decisions regarding their healthcare treatment facility needs. User(s) or patient(s) is used interchangeably herein. For example, while patients may access the application to obtain information regarding medical treatment facilities, a “user” may access application to assist a patient who may or may not be able to use the application, such as, for example, a child or incapacitated person. Furthermore, the system is capable of returning responses for multiple other information depending on request by user(s) or patient(s).

In another embodiment of the present invention provides a method for obtaining healthcare service on negotiated rates or contracted rates for user(s) or patient(s) through an application or a computer implemented tool, the method comprising:
receiving a request for services from users or patients, wherein one or more types of services are selected from the group consisting of; detail of service provider, cost of the service based on negotiated rates, emergency services, map location health record, claims processing alerts, walk-in-clinic integration, appointment alerts;
searching for information in the database;
identifying list of options with detailed information;
selecting at least one option from provided list of options;
transferring the request to service provider;
receiving acknowledgement from service provider;
sending the verification of the payment amount to a medical credit account associated with the user or patient;
approving the payment amount on the medical credit account from payer;
and transmitting the payment amount details to the health care provider;
wherein the user(s) or patient(s) receive all the required information on the spot, which makes a user(s) or patient(s) to take personalized decision regarding actions to address the needs.

User(s) or patient(s) are able to enter search criteria for finding emergency, urgent, and/or convenient care facilities by shortest wait times, closest physical proximity, highest quality ratings, etc. In determining proximity information, users may either provide their current location or indicate the exact geographic coordinates of the user's location. In other embodiments, user(s) or patient(s) may log-in or otherwise indicate their member status and obtain quicker access to entering search criteria by having their personal information automatically populated in interface, for example, upon processing the search criteria, search results are provided to the user(s) or patient(s). In receiving search results, user(s) or patient(s) can make informed decisions regarding their choice of healthcare facility for emergency, urgent, and/or convenient care.

Search criteria may be entered by a user(s) or patient(s), wherein the user(s) or patient(s) selects a specific geographical location and specific type of service or procedure desired. In this example, the user may select to view data concerning all facilities in the specified geographic area that provide the desired service or procedure and provider.

In response to a search request entered by the user(s) or patient(s) such as described above, the system provides negotiated rates or contracted rates of provider and also rating data and/or reviews. Provides may include doctors, hospitals, clinics or other providers of health-related services. The provider ratings data and reviews may include relative rating information concerning the cost and/or quality for each provider and/or services. Other data also may be displayed as desired by the implementers of the system and/or the user(s) or patient(s).

According to certain implementations, cost and quality rating data may be calculated based on historical claim data for each provider and services. For example, cost rating data may be based upon charges submitted in historical claim data related to procedure-based data, and may be presented to the user(s) or patient(s) as ratings corresponding to high, low and average charges.

In another embodiment of the present invention provides a method for obtaining healthcare services by user(s) or patient(s) through the system, the method comprising:
requesting for information of healthcare services for a particular disease or symptom;
receiving request in the system;
searching for the information in the database;
identifying list of options for service providers with detailed information;
presenting information regarding service providers by said system to said user.
selecting at least one option from provided list of options;
wherein said identifying is based on disease or symptom and location selected by user(s) or patient(s) or nearby location of the user(s) or patient(s).

The negotiated rates or contracted rates are obtained from service providers, wherein service providers include but not limited to doctors, hospitals, clinic, medical lab, medical store or pharmacies. The negotiated rates or contracted rates are provided corresponding to the medical services or procedures and instrument being used.

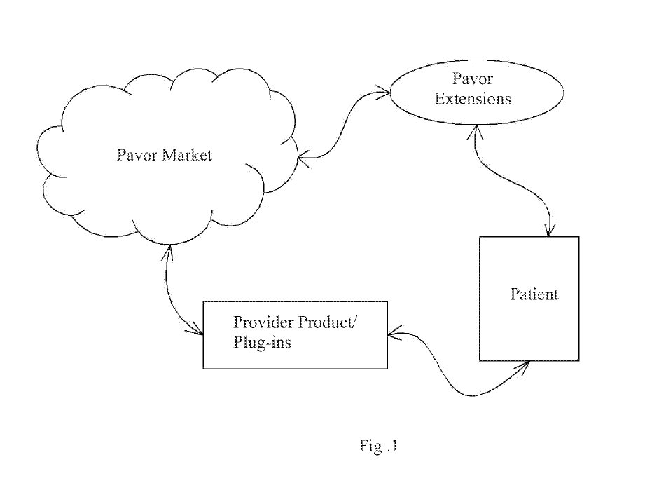

With reference to FIG. 1 is a diagrammatic representation of the system and method of the present invention in which it shows the communication among payer, service provider or their extension and user(s) or patient(s) are able to interact in a single platform.

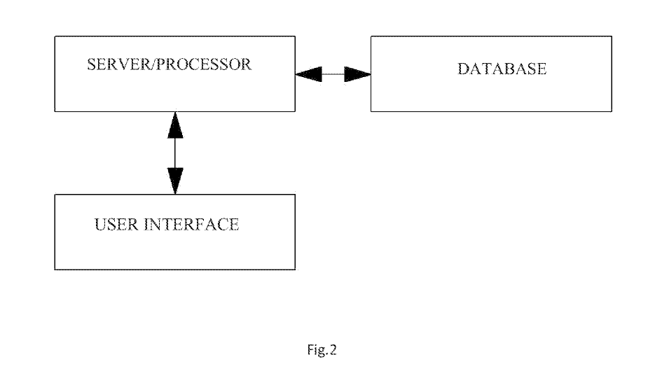

With reference to FIG. 2 is a diagram of an exemplary system for providing negotiated rates on healthcare services. The exemplary system includes a server/processor, storage database and user interface for requesting and receiving information for service provider, cost, and quality based on a particular disease or symptom. The server/processor is configured to receive search criteria, and retrieve one or more health-related listings based on the search criteria, in which the health-related listing includes associated provider quality rating data and/or cost rating data. Storage database is configured for storing health-related data and is communicatively coupled to the server/processor to enable the server/processor to retrieve health-related data. Health-related data may include provider information listings (including physicians, hospitals and other providers) and associated provider quality rating data and cost. The user interface may be provided that is communicatively coupled to the server/processor and/or storage database for facilitating user(s) or patient(s) to access health-related information.

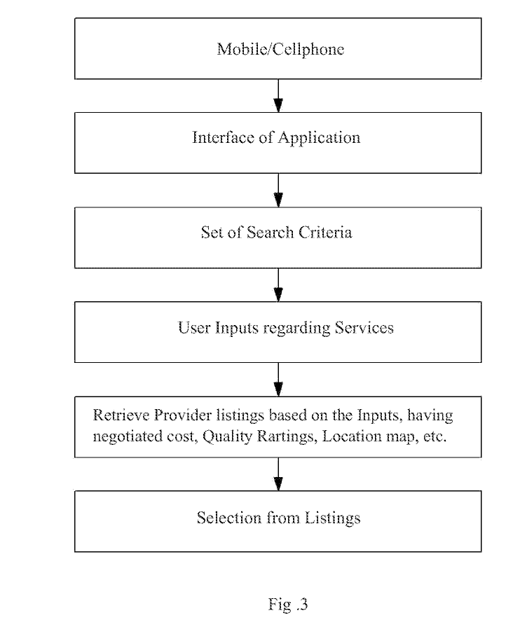

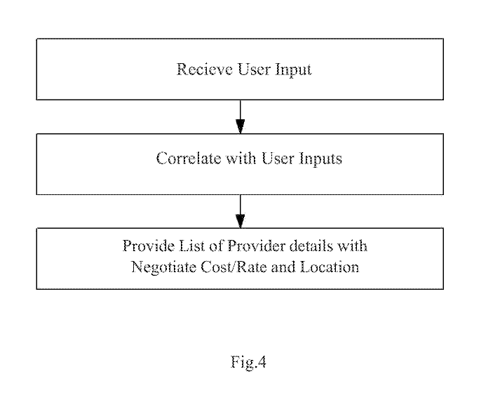

With reference to FIG. 3 and FIG. 4 are flowcharts of a method for providing healthcare services on negotiated rates. The method includes receiving search criteria, and retrieving one or more health-related listings based on the search criteria. Search criteria may be entered by a user(s) or patient(s), such as a member of an insurance plan.

Search criteria may be entered by a user(s) or patient(s), wherein the user(s) or patient(s) selects, for example, a specific geographical location and specific type of provider or service desired. In this example, the user(s) or patient(s) may select to view data concerning all healthcare providers in the selected area that provide the desired service or procedure. In response to a search request entered by the user(s) or patient(s) such as described above, the server transmits details for service provider including quality, rating and negotiated rates to user(s) or patient(s).

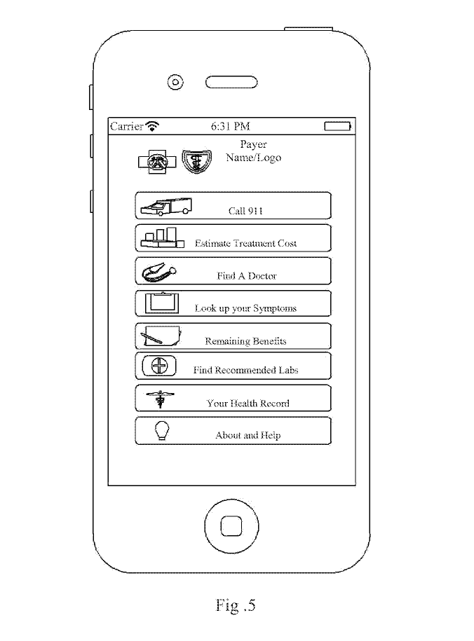

With reference to FIG. 5, the user(s) or patient(s) may initialize application on a mobile and which further starts by opening a screen. The screen may include many features such as, call 911 in case of an emergency, estimate treatment cost for a particular diseases or symptom, find a doctor, look up your symptoms, remaining benefit, find recommended labs, your health record and about and help. It is illustrated for the purpose of understanding; it may be leveled by any other alternative form. Wherein the feature remaining benefits provides the details of vision, dental, health and HAS on the same portal.

The symptoms may be sorted by alphabetical order, or by category or other intuitive organization, to allow the symptoms to be found more easily. Additionally, the symptoms may be searched by way of a symptom search box. The user(s) or patient(s) may select any one of the symptoms in order to get more information regarding that symptom.

In your health record box, a user(s) or patient(s) may check the existing record of his/her medical condition. And at last the system provides about and help box for any other help or information if required by the user(s) or patient(s).

Where the user may generally be facilitated by way of buttons or links presented in the screen. A link may be presented for symptoms, diseases, procedures and service provider such that these links may be used as shortcuts for users. For example, the symptoms list may be accessed at any time by clicking on or selecting the symptoms link. Similarly, the other links may be used to navigate to other lists or information's as will be discussed further below.

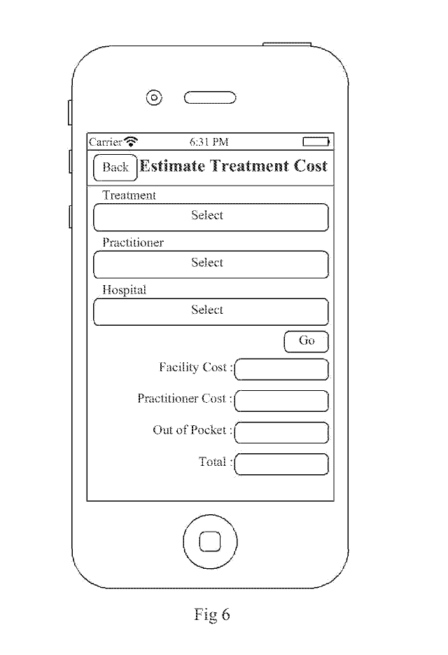

With reference to FIG. 6, the screen for the estimation treatment cost for a particular diseases or treatment link has been selected by the user such that list of search criteria is presented to the user. Here the user can calculate total cost including practitioner or doctor cost, facility cost and out of packet cost.

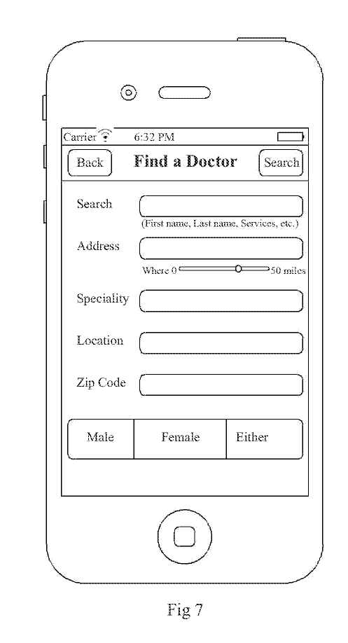

With reference to FIG. 7, the screen for searching doctor in a required location for a particular disease or symptoms.

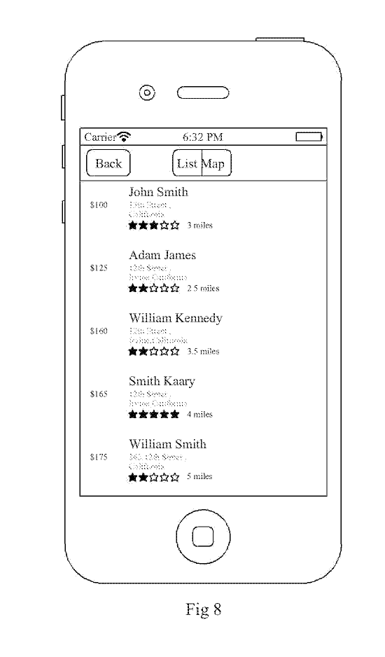

With reference to FIG. 8, the screen shows the list of doctor with negotiated rates or contracted rate and address.

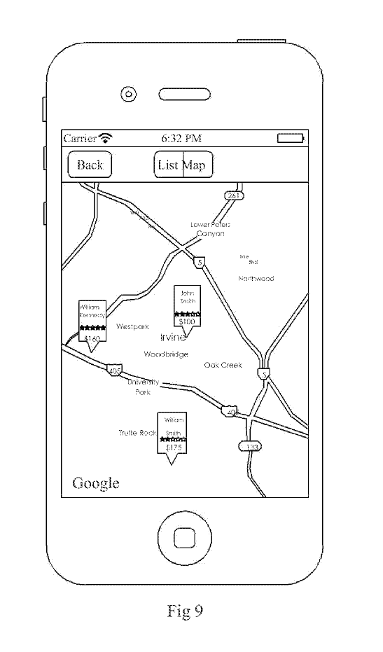

With reference to FIG. 9 shows the screen to navigate the direction to reach doctors location from the user(s) or patient(s) location.

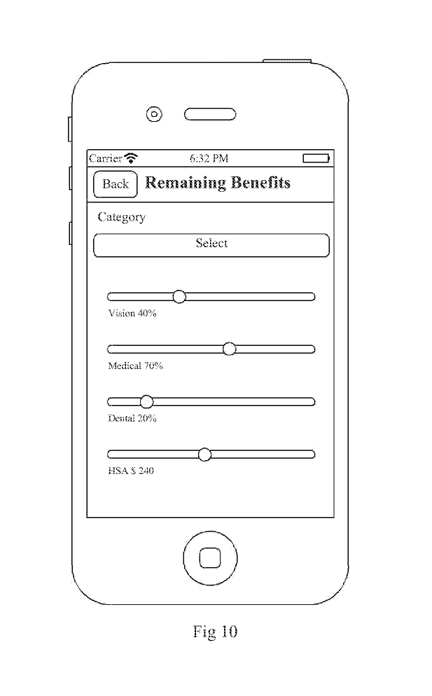

With reference to FIG. 10 shows the screen for the remaining benefits provided on services by services providers to user(s) or patient(s).

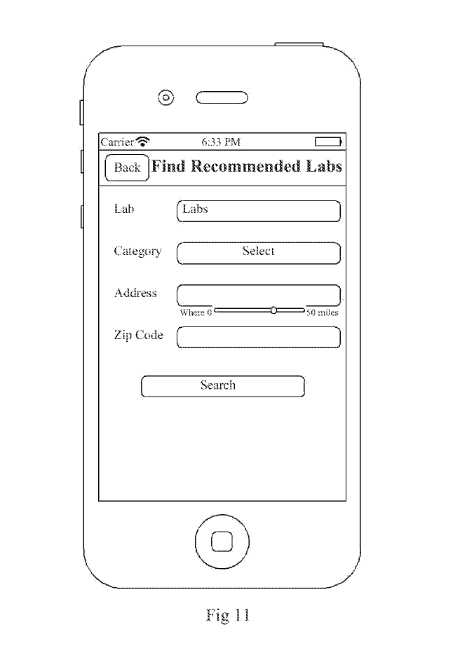

With reference to FIG. 11 shows the screen for the finding labs based on search criteria in a desired location.

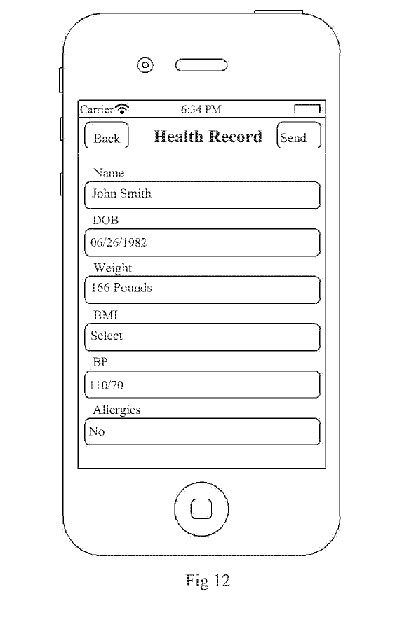

With reference to FIG. 12 show the screen for the health record of the user(s) or patient(s) existing in the system.

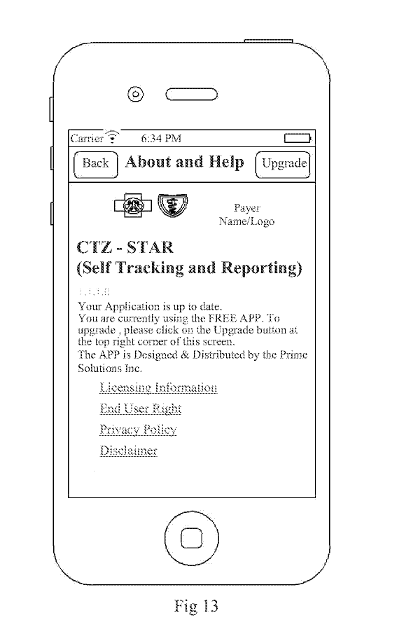

With reference to FIG. 13 shows the other help required by user(s) or patient(s).

The user(s) or patient(s) may be presented with the option to provide a location (e.g., by way of a zip code input) or to use the location determining module. Additionally, the user(s) or patient(s) may selectively determine the search radius such that only providers within certain distances, (e.g., 2 miles, 3 miles, 10 miles or some other distance) may be displayed. As an example, in FIG. 8, provider list distance with number of miles radius are displayed.

In some embodiment, the present invention provides an option of the disease correlation list wherein the diseases may be sorted by a variety of filters. For instance, the filter options may include filtering the diseases presented in the disease correlation list into disease classes corresponding to common diseases, pediatric diseases, or life threatening diseases. In this manner, the diseases included in the disease correlation list may be sorted by a variety of options by the user(s) or patient(s). The user(s) or patient(s) may have selected a disease from a disease list. In this regard, a disease information screen may be presented to the user(s) or patient(s). From the disease information screen, the user may select from a variety of information listings about the disease including, but not limited to, a description of the disease, possible tests to determine the existence of the disease, symptoms of the disease, as well as common treatments associated with the disease.

In some embodiments, when payment of all or part of the payment amount is the responsibility of at least payer other than the patient, the payer receive the claim of payment through the system or the provider may also use the system to submit a claim to a responsible payer (for example Blue Cross Blue Shield), such as a medical insurance company, a medical credit card account, or other source of funds dedicated for payment of the patient's medical expenses.

Where the system also allows the provider to submit a claim on behalf of the patient to any payer that is responsible to pay the provider for the payment amount associated with the patient encounter.

The present invention of the system also provides contact mechanism to contact directly to a healthcare practitioner for a medical consultation or in case of emergency, wherein tracking option is also available to track users or patients or service providers or both.

The system according present invention also provides for monitoring of the health condition of the user and; receiving one or more alert of the health condition based on users data presented in the application.

The system work in a circle wherein said server is operative to receive said request from user, retrieve the information from database and transmit specific information to user based on request.

The system comprises a map through which geographical location of service provider is displayed on the user(s) or patient(s) mobile screen. Where a user(s) or patient(s) may also customized the search criteria by customizing required information in desired location selected by user or nearby location of the user.

Wherein the service providers are selected based on reviews or rating or quality of service or experience. The negotiated rates or contracted rates reflect on health premium plan, such as for lesser cost users or patient gets benefit to pay lesser premium.

The disclosed systems and methods are best understood in terms of the context in which they operate in which healthcare cost transparency services may be provided.

One skilled in the art will appreciate that the embodiments provided above are exemplary and in no way limit the present invention.

Although the invention has been illustrated and described with respect to one or more implementations, equivalent alterations and modifications will occur to others skilled in the art upon the reading and understanding of this specification and the annexed drawings. In addition, while a particular feature of the invention may have been disclosed with respect to only one of several implementations, such feature may be combined with one or more other features of the other implementations as may be desired and advantageous for any given or particular application.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

The Abstract of the disclosure will allow the reader to quickly ascertain the nature of the technical disclosure. It is submitted with the understanding that it will not be used to interpret or limit the scope or meaning of the following claims.

What is claimed is:

1. A method for providing negotiated rates or contracted rates on healthcare services to user(s) or patient(s) through an application or a computer implemented tool, the method comprising:
receiving a request for services from users or patients, wherein one or more types of services are selected from the group consisting of; detail of service provider, cost of the service based on negotiated rates, emergency services, map location, health record, claims processing alerts, walk-in-clinic integration, appointment alerts;
searching for the information in the database;
identifying list of options with detailed information;
selecting at least one option from provided list of options;
transferring the request to service provider;
receiving acknowledgement from service provider;
sending the verification of the payment amount to a medical credit account associated with the user(s) or patient(s);
approving the payment amount on the medical credit account from payer;
and transmitting the payment amount details to the health care provider;
wherein the user(s) or patient(s) receive all the required information on the spot, which makes a user(s) or patient(s) to take personalized decision regarding actions to address the needs.

2. The method according to claim 1, wherein the negotiated rates or contracted rates are provided from service providers.

3. The method according to claim 2, wherein service providers include but not limited to doctors, hospitals, clinic, medical lab, medical store or pharmacies.

4. The method according to claim 1, wherein the user(s) or patient(s) is/are health plan members (Insured member).

5. The method according to claim 1, wherein the medical credit account is associated with a card or health plan.

6. The method according to claim 5, wherein the card is selected from the groups consisting of a stored value card, a medical credit card or a medical plan card.

7. The method according to claim 1, further comprising contact mechanism to contact directly to a healthcare practitioner for a medical consultation or in case of emergency.

8. The method according to claim 1, wherein acknowledgement is automatically populated and transmitted among server, user(s) or patient(s) and service provider.

9. A system for providing negotiated rates or contracted rates on healthcare services, the system comprises:
at least one server to receive request from user(s) or patient(s) regarding service providers, costs and geographical locations;
at least one searching database which communicates with the server;
identifying list of options for services which are selected from the group consisting of; detail of service provider, cost of the service based on negotiated rates, emergency services, map location, health record, claims processing alerts, walk-in-clinic integration, appointment alerts;
selecting at least one option from provided list of options;
wherein the system is a mobile application or web application.

10. The system according to claim 9 further comprises; monitoring of the health condition of the user and; receiving one or more alert of the health condition based on users data presented in the application.

11. The system according to claim 9, wherein said server is operative to receive said request from user, retrieve the information from database and transmit specific information to user based on request.

12. The system according to claim 9, wherein details of service providers includes type of services, contact information, hours of service, cost and location.

13. The system according to claim 9, wherein the geographical location of service provider is based on location selected by user or nearby location of the user.

14. The system according to claim 9, wherein location of said service providers can be identified through direction shown in the map in the application.

15. The system according to claim 9, wherein an application comprises an interface which is displayed as window or screen on the mobile.

16. The system according to claim 9, wherein the system and the negotiated rate or contracted rates are automatically upgraded or revised after a predefined time period.

17. A method for providing negotiated rates or contracted rates on healthcare services by the system, the method comprising:
requesting for information of healthcare services for a particular disease or symptom;
receiving request in the system;
searching for the information in the database;
identifying list of options for service providers with detailed information;
presenting information regarding service providers by said system to said user;
selecting at least one option from provided list of options;
wherein said identifying is based on disease or symptom and location selected by user or nearby location of the user(s) or patient(s).

18. The method according to claim 17, wherein the list of option for service providers includes sorted order of the list and specific to request by an user(s) or patient(s) for a particular disease or symptom.

19. The method according to claim 17, wherein the service providers are selected based on reviews or rating or quality of service or experience.

20. The method according to claim 17, wherein negotiated rates or contracted rates reflects on health premium plan, such as for lesser cost users or patient gets benefit to pay lesser premium.
